(19) United States
(12) Patent Application Publication
(10) Pub. No.: US 2012/0219843 A1
(43) Pub. Date: Aug. 30, 2012

(54) COMPOSITION, ENERGY STORAGE DEVICE, AND RELATED PROCESSES

(75) Inventors: David Charles Bogdan, JR., Scotia, NY (US); Michael Alan Vallance, Loudonville, NY (US); Richard Louis Hart, Broadalbin, NY (US)

(73) Assignee: GENERAL ELECTRIC COMPANY, SCHENECTADY, NY (US)

(21) Appl. No.: 13/034,184

(22) Filed: Feb. 24, 2011

(51) Int. Cl. H01M 10/0562; H01M 6/00; H01M 2/18

(52) U.S. Cl. 429/147; 429/319; 29/623.1

(57) ABSTRACT

A positive electrode composition is provided. The positive electrode composition includes at least one electroactive metal selected from the group consisting of titanium, vanadium, niobium, molybdenum, nickel, cobalt, chromium, manganese, silver, antimony, cadmium, tin, lead, iron, and zinc. The composition further includes sodium iodide, present in an amount in a range from about 0.1 weight percent to about 0.9 weight percent, based on the weight of the positive electrode composition; a first alkali metal halide; and an electrolyte salt comprising a reaction product of a second alkali metal halide and an aluminum halide, wherein the electrolyte salt has a melting point of less than about 300 degrees Celsius. Related devices, such as a UPS device, also form embodiments of this invention.

### BACKGROUND

The invention includes embodiments that relate to an electrode composition and method of its making. The invention also includes embodiments that relate to an electrode for an energy storage device.

Metal chloride batteries, especially sodium-nickel chloride batteries with a molten sodium anode and a beta-alumina solid electrolyte, are widely employed for energy storage applications. When the metal chloride batteries are employed in mobile applications like hybrid locomotives or plug-in electric vehicles (PHEV), the batteries should be capable of providing power surges (high currents), during discharging of the battery. This should be achieved without a significant loss in the working capacity and the cycle life of the battery. To provide better fuel economy via regenerative braking (a power generation system, e.g., in PHEV's), better electric efficiency is desirable, since the ratio of discharged to charged energy decreases with an increase in current. Attempts have been made to provide positive electrode compositions that can tolerate power surges. In general, there exists a need for an improved solution to the long-standing problem of high current cell performance. Modifying the positive electrode composition may provide one such solution, since an improved composition may significantly improve the cell working capacity, and decrease the capacity degradation rate.

### BRIEF DESCRIPTION

In accordance with one aspect of the present invention, a positive electrode composition is provided. The positive electrode composition includes at least one electroactive metal selected from the group consisting of titanium, vanadium, niobium, molybdenum, nickel, cobalt, chromium, manganese, silver, antimony, cadmium, tin, lead, iron, and zinc. The composition further includes sodium iodide, present in an amount in a range from about 0.1 weight percent to about 0.9 weight percent, based on the weight of the positive electrode composition. The composition also includes a first alkali metal halide; and an electrolyte salt. The electrolyte salt includes a reaction product of a second alkali metal halide and an aluminum halide. The electrolyte salt has a melting point of less than about 300 degrees Celsius. The first alkali metal halide and the second alkali metal halide independently include a halide selected from chlorine, bromine, and fluorine.

In accordance with one aspect of the present invention, an article is provided. The article includes a positive electrode composition, as mentioned above and further described below.

In accordance with another aspect of the present invention, an energy storage device is provided. The device includes (a) a first compartment comprising an alkali metal; (b) a second compartment including a positive electrode composition, as described in detail herein; and (c) a solid separator capable of transporting alkali metal ions between the first and the second compartments.

In accordance with yet another aspect of the present invention, an uninterruptable power supply device is provided. The article includes a positive electrode composition, as described in detail herein.

Another embodiment is directed to a method for preparation of the energy storage device described herein. The method comprises providing a housing having an interior surface defining a volume; disposing a separator inside the housing, wherein the separator has a first surface that defines at least a portion of a first compartment, and a second surface that defines a second compartment; wherein the first compartment is in ionic communication with the second compartment through the separator; and disposing a positive electrode composition (as described herein) within the second compartment.

Yet another embodiment is directed to a positive cathode composition. The positive cathode composition includes nickel in an amount in a range from about 10 volume percent to about 20 volume percent, based on the volume of the positive electrode composition. The positive electrode composition further includes sodium iodide present in an amount in a range from about 0.1 weight percent to about 0.9 weight percent, based on the weight of the positive electrode composition. The composition also includes a first alkali metal halide selected from sodium chloride, sodium fluoride, sodium bromide, and a combination thereof; and an electrolyte salt. The electrolyte salt includes a reaction product of (a) a second alkali metal halide selected from sodium chloride, sodium fluoride, sodium bromide, and a combination thereof; and (b) an aluminum halide. The electrolyte salt has a melting point of less than about 300 degrees Celsius.

### BRIEF DESCRIPTION OF THE FIGURES

These and other features, aspects, and advantages of the present invention will become better understood when the following detailed description is read with reference to the accompanying drawings in which like characters represent like parts throughout the drawings, wherein:

FIG. 1 is a schematic view illustrating a front cross-sectional view of an electrochemical cell in accordance with an embodiment of the invention;

FIG. 2 is a graphical representation of the discharge time during the charging cycle for a positive electrode composition in accordance with the embodiments described herein.

### DETAILED DESCRIPTION

The invention relates generally to a positive electrode composition. More particularly, the invention relates to a positive electrode composition for an energy storage device. The invention also includes embodiments that relate to a method of making the energy storage device.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function. These terms may also qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances the event or capacity cannot occur—this distinction is captured by the terms “may” and “may be”.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

“Optional” or “optionally” means that the subsequently described event or circumstance may or may not occur, and that the description includes instances where the event occurs and instances where it does not.

Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

When introducing elements of various embodiments of the present invention, the articles “a,” “an,” “the,” and “said” are intended to mean that there are one or more of the elements. The terms “comprising,” “including,” and “having” are intended to be inclusive, and mean that there may be additional elements other than the listed elements. Furthermore, the terms “first,” “second,” and the like, herein do not denote any order, quantity, or importance, but rather are used to distinguish one element from another.

Embodiments of the invention described herein address the noted shortcomings of the state of the art. These embodiments advantageously provide an improved positive electrode composition for use in a metal-metal chloride battery, for example a sodium-nickel chloride battery. The positive electrode composition includes at least one electroactive metal selected from the group consisting of titanium, vanadium, niobium, molybdenum, nickel, cobalt, chromium, manganese, silver, antimony, cadmium, tin, lead, iron, and zinc. The composition further includes sodium iodide, present in an amount in a range from about 0.1 weight percent to about 0.9 weight percent, based on the weight of the positive electrode composition; at least one first alkali metal halide; and an electrolyte salt comprising a reaction product of a second alkali metal halide and a aluminum halide, wherein the electrolyte salt has a melting point of less than about 300 degrees Celsius; and wherein the first alkali metal halide and the second alkali metal halide independently comprise a halide selected from chlorine, bromine, and fluorine. The positive electrode composition may also include products of the chemical or electrochemical interaction of the various elements listed herein. Advantageously, the invention solves or minimizes problems associated with high current cell performance, by way of providing an improved positive electrode composition.

The improved positive electrode composition may help in increasing the maximum discharge power density of high-temperature metal-halide/sodium cells. This may also increase the amount of time that these cells can sustain high-power discharging. Embodiments of the invention also provide an article and an energy storage device comprising the positive electrode composition described herein. More particularly, the energy storage device includes an uninterruptable power supply (UPS) device, which is a device that is designed to deliver high power for short duration. Typically, the UPS device is designed to deliver high power for a period of about 1 second, to about 2 hours, at average rates of about 0.5 D to about 10 D (wherein, fD is a rate corresponding to full discharge of the energy storage battery in 1/f hour. Additionally, the increased power density may help in reducing the number of cells per article, or per energy storage device, which may directly lead to a reducing the cost of the article or device. Further, increasing the useful life of the article or the energy storage device may lower the cost per product per year installed. Embodiments of the invention also provide a method of forming the energy storage device.

As used herein, a cathodic material is a material that supplies electrons during the charging process of a battery, and is present as part of a redox reaction. The anodic material accepts electrons during the charging process of a battery, and is present as part of the redox reaction. The positive electrode i.e., the cathode, includes cathodic materials having differing functions: an electrode material, a support structure, and a current collector. The electrode materials are present in the positive electrode as participating electrochemical reactants, both in their oxidized and reduced state, or at some state between full oxidation or reduction. The electroactive metal is a metal that oxidizes in molten sodium tetrachloroaluminate, resulting in a metal salt above the oxidation potential of aluminum (about 1.58 V vs. Na), and below the oxidation potential of chloride (about 4.15 V vs. Na).

The support structure usually does not undergo much change during any chemical reaction during the charge/discharge, but does provide electron transport, and supports the electrode material as the electrode material undergoes chemical reaction and allows for a surface upon which solids may precipitate as needed. An electrolyte is a medium that provides an ion transport mechanism between the positive and negative electrodes of a cell, and may act as a solvent for the oxidized form of the electrode material. Additives that facilitate the ion transport mechanism, but do not themselves provide the mechanism, are distinguished from the electrolyte itself.

As noted, in one aspect of the present invention, a positive electrode composition is provided that includes at least one electroactive metal, sodium iodide, present in an amount in a range from about 0.1 weight percent to about 0.9 weight percent, based on the weight of the positive electrode composition; at least one first alkali metal halide; and an electrolyte salt comprising a reaction product of a second alkali metal halide and an aluminum halide, wherein the electrolyte salt has a melting point of less than about 300 degrees Celsius. The first alkali metal halide and the second alkali metal halide independently include a halide selected from chlorine, bromine, and fluorine. In one embodiment, the electroactive metal may be at least one transition metal selected from the group consisting of titanium, vanadium, niobium, molybdenum, nickel, cobalt, chromium, manganese, silver, antimony, cadmium, tin, lead, iron, and zinc. In one embodiment, the electroactive metal may be at least one metal selected from antimony, cadmium, tin, lead, iron, and zinc. In yet another embodiment, the electroactive metal may be antimony. In other embodiments, some or all of the electroactive metal may optionally include a salt form of the electroactive metal. In one embodiment, the electroactive metal salt may be in the form of a nitrate, sulfide, or halide of the electroactive metal. The halide salts are preferred in some instances.

In one embodiment, the amount of electroactive metal present in the positive electrode composition is in a range from about 10 volume percent to about 20 volume percent, based on the volume of the positive electrode composition. In another embodiment, the amount of electroactive metal present is in a range from about 11 volume percent to about 19 volume percent. In yet another embodiment, the amount of electroactive metal present is in a range from about 12 volume percent to about 18 volume percent. One skilled in the art will appreciate that the electroactive metal, for example, nickel, is the positive electrode grid. In one embodiment, if the amount of nickel is not sufficient to percolate electronic current, the cell may not function as expected. In another embodiment, if the amount of nickel is in excess, it is at the expense of the electrolyte slat and/or alkali metal halide, both of which perform critical functions.

The positive electrode composition includes sodium iodide. In one embodiment, the amount of sodium iodide present in the positive electrode composition is in a range from about 0.1 weight percent to about 0.9 weight percent, based on the weight of the positive electrode composition. In another embodiment, the amount of sodium iodide present is in a range from about 0.2 weight percent to about 0.8 weight percent. In yet another embodiment, the amount of sodium iodide present is in a range from about 0.3 weight percent to about 0.7 weight percent. As noted in other portions of this disclosure, the present inventors have discovered that the presence of sodium iodide at these reduced levels, as compared to sodium iodide levels used in other positive electrode compositions, can provide significant advantages for electrochemical cells which incorporate such positive electrodes. (For example, please refer to U.S. Pat. No. 5,972,533, incorporated herein by reference, which describes in detail the working of an electrochemical cell).

The positive electrode composition also includes a first alkali metal halide. In one embodiment, the first alkali metal halide is at least one alkali metal halide selected from sodium chloride, sodium bromide, sodium fluoride, potassium chloride, potassium bromide, potassium fluoride, lithium chloride, lithium bromide, lithium fluoride, and cesium chloride.

In one embodiment, the amount of the first alkali metal halide present in the positive electrode composition is in a range from about 20 volume percent to about 50 volume percent, based on the volume of the positive electrode composition. In another embodiment, the amount of the first alkali metal halide present in the positive electrode composition is in a range from about 22 volume percent to about 48 volume percent. In yet another embodiment, the amount of the first alkali metal halide present in the positive electrode composition is in a range from about 25 volume percent to about 45 volume percent.

The electrolyte salt comprising the reaction product of a second alkali metal halide and an aluminum halide usually has a melting point of less than about 300 degrees Celsius. In one embodiment, the electrolyte salt has a melting point in a range from about 300 degrees to about 250 degrees Celsius, from about 250 degrees Celsius to about 200 degrees Celsius, or from about 200 degrees Celsius to about 150 degrees Celsius. In one embodiment, the electrolyte salt has a melting point of about 185 degrees Celsius.

In one embodiment, the second alkali metal halide is at least one alkali metal halide selected from sodium chloride, sodium bromide, sodium fluoride, potassium chloride, potassium bromide, potassium fluoride, lithium chloride, lithium bromide, lithium fluoride, and cesium chloride. In one embodiment, the second alkali metal halide is sodium chloride. In one embodiment, the metal halide of the electrolyte salt, as mentioned above, is aluminum chloride.

In one embodiment, the amount of electrolyte salt employed is in a range of about 22 weight percent to about 35 weight percent, based on the total amount of the positive electrode composition. In another embodiment, the amount of electrolyte salt employed is in a range of about 25 weight percent to about 32 weight percent, based on the total amount of the positive electrode composition. In yet another embodiment, the amount of electrolyte salt employed is in a range of about 28 weight percent to about 30 weight percent, based on the total amount of the positive electrode composition.

In one embodiment, the second alkali metal halide and the aluminum halide of the electrolyte salt are present in a molar ratio in a range from about 0.5:0.5 to about 0.33:0.67 in the reaction product. In another embodiment, the second alkali metal halide and the aluminum halide are present in a molar ratio in a range from about 0.53:0.47 to about 0.45:0.55 in the reaction product. In yet another embodiment, when the alkali metal halide is sodium chloride and the aluminum halide used is aluminum chloride, the ratio is typically about 0.51:0.49 to about 0.48:0.52. In one embodiment, the electrolyte salt is sodium tetrachloroaluminate, usually formed as a reaction product of sodium chloride and aluminum chloride.

In one embodiment, the positive electrode composition may further include aluminum, i.e., in a form other than an electrolyte salt or an aluminum halide. Usually, the aluminum would be in elemental form, e.g., aluminum metal flakes or particles. The aluminum may assist in improving the porosity of the granules formed using the electroactive metal, iron, and alkali metal halide, described in the Examples. In one embodiment, the amount of aluminum present in the positive electrode composition is in a range from about 0.2 volume percent to about 0.5 volume percent, based on the volume of the positive electrode composition. In another embodiment, the amount of aluminum present in the positive electrode composition is in a range from about 0.25 volume percent to about 0.45 volume percent. In yet another embodiment, the amount of aluminum present in the positive electrode composition is in a range from about 0.3 volume percent to about 0.4 volume percent.

In one embodiment (though not all embodiments, as discussed below), the positive electrode composition may further comprise sulfur, in the form of molecular sulfur or a sulfur-containing compound. If present, the level of sulfur is usually in the range from about 0.1 weight percent to about 3 weight percent, based on the total weight of the positive electrode composition.

In some other, preferred embodiments, the positive electrode composition is substantially free of sulfur, i.e., containing, at most, impurity levels. The absence of sulfur is desirable in some cases because sulfur may be corrosive to diffusion bonds between ceramics and metals, which are often used in the electrochemical cells. Also, sulfides have, in some cases, been known to reduce performance in UPS applications. In one embodiment, the positive electrode composition may include other additives that may affect the performance of an energy storage device. Such performance additives may increase ionic conductivity, increase or decrease solubility of the charged cathodic species, improve wetting of a solid electrolyte i.e., the separator, by a molten electrolyte, or prevent ripening of the positive electrode microdomains, to name several utilities. In one embodiment, the performance additive may be present in an amount that is less than about 5 mole percent compared to the total combined moles of the first alkali metal halide, the electrolyte salt, and the electroactive metal present in the positive electrode composition. In one embodiment, the performance additive may be alkali metal halide salt. In one embodiment, the performance additive may comprise a bromide salt, or a fluoride salt of an alkali metal halide. Suitable examples of performance additives include sodium fluoride and sodium bromide.

In accordance with one aspect of the present invention, an article is provided. The article includes a positive electrode composition, as described herein. As one example, the article may be in the form of an energy storage device. The device usually includes (a) a first compartment comprising an alkali metal; (b) a second compartment including a positive electrode composition, as described herein; and (c) a solid separator capable of transporting alkali metal ions between the first and the second compartments.

The device also includes a housing that usually has an interior surface defining a volume. A separator is disposed in the volume. The separator has a first surface that defines at least a portion of a first compartment, and a second surface that defines a second compartment. The first compartment is in ionic communication with the second compartment through the separator. As used herein, the phrase “ionic communication” refers to the traversal of ions between the first compartment and the second compartment, through the separator.

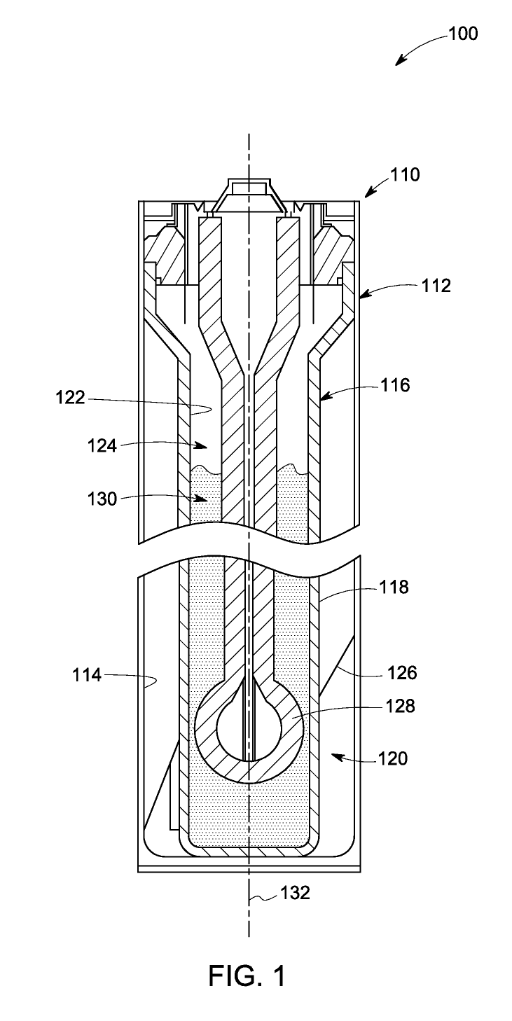

Referring to FIG. 1, an electrochemical cell 100 is provided. More particularly, a front cross-sectional view 110 of the cell is depicted. The electrochemical cell 100 includes a housing 112. The housing 112 usually has an interior surface 114, defining a volume. A separator 116 is disposed inside the housing 112. The separator 116 has a first surface 118 that defines a first compartment 120, i.e., an anode compartment. The separator has a second surface 122 that defines a positive electrode compartment 124. An anode current collector 126 is connected to the anode compartment 120. A positive electrode current collector 128 is connected to the positive electrode compartment 124. A positive electrode composition 130 is disposed inside the positive electrode compartment 124. The positive electrode composition 130 mainly includes at least one electroactive metal, sodium iodide, a first alkali metal halide, and an electrolyte salt. The first alkali metal halide may include a halide selected from chloride, bromide, and fluoride. Sodium iodide is usually present in an amount in a range from about 0.1 weight percent to about 0.9 weight percent, based on the weight of the positive electrode composition. The working temperature of the electrochemical cell 100, when it is a sodium-nickel chloride cell, is about 300 degrees Celsius.

The housing can be sized and shaped to have a cross-sectional profile that is square, polygonal, or circular, for example. Typically, the aspect ratio of the housing is determined by the aspect ratio of the separator. In many cases, the walls of the separator should be slender, to reduce the average ionic diffusion path length. In one embodiment, the height to effective diameter ratio (2×(square root of (cross-sectional area/pi)) of the housing is greater than 5 times, and in another embodiment it is greater than 7 times. The housing can be formed from a material that is a metal, ceramic, or a composite; or some combination thereof. The metal can be selected from nickel or steel, as examples; and the ceramic is often a metal oxide.

Typically, the anode compartment is empty in the ground state (uncharged state) of the electrochemical cell, and is filled with metal from reduced metal ions that move from the positive electrode compartment to the anode compartment through the separator, during operation of the cell. The anodic material, for example, sodium, is molten during use. The first compartment or the anode compartment may receive and store a reservoir of anodic material.

Additives suitable for use in the anodic material may include a metal oxygen scavenger. Suitable metal oxygen scavengers may include one or more of manganese, vanadium, zirconium, aluminum, or titanium. Other useful additives may include materials that increase wetting of the separator surface 116 defining the anode compartment, by the molten anodic material. Additionally, some additives or coatings may enhance the contact or wetting between the separator and the current collector, to ensure substantially uniform current flow throughout the separator.

The separator is usually an alkali metal ion conductor solid electrolyte that conducts alkali metal ions during use between the first compartment and the second compartment. Suitable materials for the separators may include an alkali-metal-beta′-alumina, alkali-metal-beta″-alumina, alkali-metal-beta′-gallate, or alkali-metal-beta″-gallate. In various embodiments, the solid separator may include a beta-alumina, a beta″-alumina, a gamma alumina, or a micromolecular sieve such as, for example, a tectosilicate, such as a felspar, or a felspethoid. Other exemplary separator materials include zeolites, for example a synthetic zeolite such as zeolite 3A, 4A, 13X, ZSM-5; rare-earth silicophosphates; silicon nitride; or a silicophosphate; a beta′-alumina; a beta″-alumina; a gamma alumina; a micromolecular sieve; or a silicophosphate (NASICON: Na₃Zr₂Si₂PO₁₂). In some preferred embodiments, the separator includes a beta alumina. In one embodiment, a portion of the separator is alpha alumina, and another portion of the separator is beta alumina. The alpha alumina may be relatively more amenable to bonding (e.g., compression bonding) than beta alumina, and may help with sealing and/or fabrication of the energy storage device.

The separator can be sized and shaped to have a cross-sectional profile that is square, polygonal, circular, or clover leaf, to provide a maximum surface area for alkali metal ion transport; and can have a width to length ratio that is greater than about 1:10, along a vertical axis 132. In one embodiment, the length to width ratio of the separator is in a range of from about 1:10 to about 1:5, from about 1:5 to about 1:1, from about 1:1 to about 5:1, from about 5:1 to about 10:1, or from about 10:1 to about 15:1. The ionic material transported across the separator between the anode compartment and the positive electrode compartment can be an alkali metal. Suitable ionic materials may include cationic forms of one or more of sodium, lithium and potassium.

The separator may be stabilized by the addition of small amounts of a dopant. The dopant may include one or more oxides selected from lithia, magnesia, zinc oxide, and yttria. These stabilizers may be used alone or in combination with themselves, or with other materials. In one embodiment, the separator comprises a beta alumina separator electrolyte (BASE), and may include one or more dopants.

As noted above, the separator is disposed within the volume of the housing 112. The separator may have a cross-sectional profile normal to a vertical axis 132 of the housing 112. Examples of profiles/shapes include a circle, a triangle, a square, a cross, a clover leaf, or a star. Alternatively, the cross-sectional profile of the separator can be planar about the vertical axis 132. A planar configuration (or one with a slight dome) may be useful in a prismatic or button-type battery configuration, where the separator is domed or dimpled. Similarly, the separator can be flat or undulated. In one embodiment, the solid separator may include a shape which may be flat, undulated, domed or dimpled, or comprises a shape with a cross-sectional profile that may be an ellipse, triangle, cross, star, circle, cloverleaf, rectangular, square, or multi-lobal. The separator can be a tubular container in one embodiment, having at least one wall. The wall can have a selected thickness; and an ionic conductivity. The resistance across the wall may depend in part on that thickness. In some cases, the thickness of the wall can be less than about 5 millimeters. A cation facilitator material can be disposed on at least one surface of the separator, in one embodiment. The cation facilitator material may include, for example, selenium, as discussed in published U.S. Patent Application No. 20100086834, incorporated herein by reference.

Optionally, one or more shim structures can be disposed within the volume of the housing. The shim structures support the separator within the volume of the housing. The shim structures can protect the separator from vibrations caused by the motion of the cell during use, and thus reduce or eliminate movement of the separator relative to the housing. In one embodiment, a shim structure functions as a current collector.

The energy storage device may have a plurality of current collectors, including anode current collectors and positive electrode current collectors. The anode current collector is in electrical communication with the anode chamber, and the positive electrode current collector is in electrical communication with the contents of the positive electrode chamber. Suitable materials for the anode current collector may include tungsten, titanium, nickel, copper, molybdenum, and combinations of two or more of the foregoing metals. Other suitable materials for the anode current collector may include carbon. The positive electrode current collector may be a wire, paddle or mesh formed from platinum, palladium, gold, nickel, copper, carbon, or titanium. The current collector may be plated or clad. In one embodiment, the current collector is free of iron.

The second compartment includes a positive electrode composition of the present invention. As noted above, the positive electrode composition comprises: at least one electroactive metal; sodium iodide; an alkali metal halide, and an electrolyte salt. The electroactive metal may be at least one selected from the group consisting of titanium, vanadium, niobium, molybdenum, nickel, cobalt, chromium, manganese, silver, antimony, cadmium, tin, lead, iron, and zinc.

In one embodiment, the alkali metal forming the first alkali metal halide may be sodium, and the separator may be beta-alumina. In another embodiment, the alkali metal forming the first alkali metal halide may be potassium or lithium, with the separator then being selected to be compatible therewith. For example, in embodiments where the ions include potassium, silver, strontium, and barium cations, the separator material may include beta alumina. In certain other embodiments, where lithium cations are used, a lithiated borophosphate BPO₄—Li₂O, may be employed as the separator material.

A plurality of the electrochemical cells can be organized into an energy storage system. Multiple cells can be connected in series or parallel, or in a combination of series and parallel. For convenience, a group of coupled cells may be referred to as a module or pack. The ratings for the power and energy of the module may depend on such factors as the number of cells in the module. Other factors may be based on end-use application specific criteria.

In accordance with one aspect of the present invention, an uninterruptable power supply device is provided. The device includes a positive electrode composition, as described previously. The primary role of any UPS device is to provide short-term power when the input power source fails. However, most UPS units are also capable in varying degrees of correcting common utility power problems, such as for example: (i) Power failure: defined as a total loss of input voltage; (ii) Surge: defined as a momentary or sustained increase in the mains voltage (iii) Sag: defined as a momentary or sustained reduction in input voltage, (iv) Spikes, defined as a brief high voltage excursion, (v) Noise, defined as a high frequency transient or oscillation, usually injected into the line by nearby equipment, (vi) Frequency instability: defined as temporary changes in the mains frequency, and (vii) Harmonic distortion defined as a departure from the ideal sinusoidal waveform expected on the line.

The general categories of modern UPS systems are on-line, line-interactive, or standby. An on-line UPS uses a “double conversion” method of accepting AC input, rectifying to DC for passing through the rechargeable battery, then inverting back to 120V/230V AC for powering the protected equipment. A line-interactive UPS maintains the inverter in line and redirects the battery's DC current path from the normal charging mode to supplying current when power is lost. In a standby system, the load is powered directly by the input power; and the backup power circuitry is only invoked when the utility power fails.

In accordance with another aspect of the present invention, a method for the preparation of the energy storage device is provided. The method comprises providing a housing having an interior surface defining a volume; disposing a separator inside the housing, wherein the separator has a first surface that defines at least a portion of a first compartment, and a second surface that defines a second compartment; wherein the first compartment is in ionic communication with the second compartment through the separator. A positive electrode composition (as described previously) is disposed in the second compartment, for example, as discussed in the example section below. The method of the invention may include taking the battery through a plurality of battery charge/discharge cycles, to activate or condition the positive electrode composition material.

In one embodiment, the energy storage device may be rechargeable over a plurality of charge-discharge cycles. In another embodiment, the energy storage device may be employed in a variety of applications; and the plurality of cycles for recharge is dependent on factors such as charge and discharge current, depth of discharge, cell voltage limits, and the like.

Various embodiments of the energy storage system can store an amount of energy that is in a range of from about 0.1 kiloWatt hours (kWh) to about 100 kWh. One embodiment of the energy storage system has an energy-by-weight ratio of greater than about 100 Watt-Hours per kilogram, and/or an energy-by-volume ratio of greater than about 200 Watt-Hours per liter. Another embodiment of the energy storage system has a specific power rating of greater than about 150 Watts per kilogram; and/or an energy-by-volume ratio of greater than about 300 Watt-Hours per liter.

Some of the suitable energy storage systems may have an application specific power to energy ratio of less than about 10 per hour to about 1 per hour. In one embodiment, the specific power to energy ratio is in a range from about 1:1 to about 2:1, from about 2:1 to about 4:1, from about 4:1 to about 6:1, from about 6:1 to about 8:1, or from about 8:1 to about 10:1. In other embodiments, the power to energy ratio is in range from about 1:1 to about 1:2, from about 1:2 to about 1:4, from about 1:4 to about 1:6, from about 1:6 to about 1:8, or from about 1:8 to about 1:10. In one embodiment, the range is from about 1:1 to 3:1.

In one embodiment, a heat management device maintains the temperature of the energy storage system. The heat management device can warm the energy storage system if too cold, and can cool the energy storage system if too hot, to prevent an accelerated cell degradation. The heat management system includes a thaw profile that can maintain a minimal heat level in the anode and positive electrode chambers, to avoid freezing of cell reagents.

Another embodiment of the invention provides an energy management system that includes a second energy storage device that differs from the first energy storage device. This dual energy storage device system can address the ratio of power to energy, in that a first energy storage device can be optimized for efficient energy storage, and the second energy storage device can be optimized for power delivery. The control system can draw from either energy storage device as needed, and charge back either energy storage device that needs such a charge.

Suitable second energy storage devices, for the power piece, include a primary battery, a secondary battery, a fuel cell, or an ultracapacitor. A suitable secondary battery may be a lithium battery, lithium ion battery, lithium polymer battery, or a nickel metal hydride battery.

### EXAMPLES

The following examples illustrate methods and embodiments in accordance with the invention, and as such should not be construed as imposing limitations upon the claims. Unless specified otherwise, all of the components are commercially available from common chemical suppliers as indicated in Table 1 below.

TABLE 1

| Material | Source | Properties |
|---|---|---|
| Nickel 255 (metal | Inco Special | 97.9 percent pure, 0.6 square |
| nickel powder, Ni) | products | meters per gram surface area, |
| | | 2.2 to 2.8 micrometers particle |
| | | size) |
| Sodium Chloride | Custom Powders | 99.99 percent pure |
| (NaCl) | Ltd, UK | |
| Iron (metal iron | Alfa Aesar Item | less than 10 micrometers particle |
| powder) (Fe) | #00170, | size, 99.9 percent pure |
| Aluminum powder | Alfa Aesar Item | −100 + 325 mesh particle size, |
| (Al) | #42919 | 99.97 percent pure |
| Sodium Fluoride | Sigma Aldrich | ~99 percent pure |
| (NaF) | | |
| Sodium iodide (NaI) | Sigma Aldrich | ~99 percent pure |

The sodium chloride (NaCl) was heat treated at 220 degrees Celsius under vacuum, and milled to an average particle size of 90 percent less than 75 micrometers in a laboratory mill, in a dry glove box. Positive electrode materials including metal nickel powder, sodium chloride, sodium fluoride, sodium iodide, and iron, and aluminum powder were pressed at ambient room temperature (typically 18 degree Celsius to about 25 degree Celsius), under a linear pressure of about 110 bar to about 115 bar, using an Alexanderwerk WP50N/75 Roll Compactor/Milling Machine. The pressurized material was ground under a rotating mill into granules; and the fraction containing a particle size of about 0.325 to about 1.5 millimeters was used for the cell assembly.

### Preparation of Electrolyte Salt: Sodium Tetrachloroaluminate

Sodium chloride and aluminum chloride were mixed and melted together to produce sodium tetrachloroaluminate (NaAlCl₄). Aluminum chloride was volatile when melted, so mixing and melting of the electrolyte salt was done as a separate step, before electrochemical cell fabrication.

Preparation of the electrolyte salt was carried out in a nitrogen purge box, to keep the materials dry. To produce a 750 gram batch of NaCl-rich (basic) sodium tetrachloroaluminate, 500 grams of aluminum chloride and 250 grams of sodium chloride were mixed in a 500-milliliter reaction vessel. The reaction vessel was sealed with a clamped lid equipped with a gas outlet that was connected to a mineral oil bubbler to relieve any pressure.

The reaction vessel containing the dry powders was heated to 330 degrees Celsius, which was above the melting point of the electrolyte salt mixture. Once melted, about 5 grams to 10 grams of aluminum powder was introduced to the molten salt. The aluminum powder, which oxidizes readily, acts to scavenge impurities present in the raw materials.

Once melted, with impurities precipitated out, the sodium tetrachloroaluminate was filtered to remove the aluminum powder and the precipitates. The molten salt was filtered through a heated (from about 200 to about 300 degrees Celsius) glass frit (25 micrometers minimum pore size). The filtered molten salt was collected on aluminum foil. Once the filtered molten salt had solidified, it was manually chipped into smaller pieces, and then milled in a dedicated, laboratory-scale, grinding mill for 60 seconds. The sodium tetrachloroaluminate powder was stored in a glove box for use in cell fabrication as an electrolyte salt. Optionally, where needed, a portion of the sodium tetrachloroaluminate powder was combined with nickel chloride salt and sodium chloride, to produce a ternary electrolyte, which was stored in a glove box for use in cell fabrication. The electrolyte may be prepared in a manner discussed herein, or can be directly obtained form Sigma Aldrich.

### Preparation of Electrochemical Cell

The electrochemical cell 100 was assembled as follows. Separator tubes 116, cylindrical or cloverleaf in shape, were produced according to known methods; or were commercially obtained. Each tube 116 was ceramic sodium conductive beta″-alumina. The cylinder dimensions were 228 millimeters length, 36 millimeters, internal diameter, and 38 millimeters, outside diameter. These are dimensions from lobe tip to lobe tip, when a clover leaf shaped separator tube was employed. Each ceramic separator tube was glass sealed to an alpha alumina collar, to form an assembly. Each assembly was placed in a stainless steel housing 112 that served as the housing to form an electrochemical cell. The housing size was about 38 millimeters×38 millimeters×230 millimeters.

The electrode composition granules prepared using the procedure mentioned above, were placed in the β″-alumina tube. The β″-alumina tube was pre-assembled with an anode chamber and a positive electrode current collector, and densified by vibration on a vibratory shaker in a nitrogen filled glove box. The positive electrode was then injected with the molten sodium tetrachloroaluminate NaAlCl₄ (as prepared above), under vacuum at 280 degrees Celsius. Following this, the cell cap was welded at a temperature of about 230 degrees Celsius inside the glove box, using a MaxStar Miller Welder, with ultra-high purity argon purge, and tested for leaks.

### Cell Test Protocol

Cell testing was performed with a 100 A, 10V, multi-channel Digatron BTS600 battery testing system. The cell was connected with four cables: positive and negative potential sense and positive and negative current supply. The positive voltage and current cables were connected to the positive tab. The negative voltage and current cables were connected to the negative tab.

All cells were assembled in the discharged state. The testing protocol was as follows:
1. Starting at 80 mA and ramping up to 5.5 A over time, charge to 2.67V, then at 2.67V to a current of 500 mA, while at 330° C.
2. Reduce temperature to 300° C. and discharge at −16 A to 1.8V or 32 Ah.
3. Charge at 10 A to 2.67V, then at 2.67V down to 500 mA.
4. Discharge at −16 A to 1.8V or 32 Ah.
5. Repeat steps 3 and 4 for a total of 10 cycles.
6. Charge at 15 A to 2.67V, then at 2.67V to a current of 500 mA.
7. Discharge at −60 W to 22 Ah or 1.8V.
8. Charge at 15 A to 2.67V, then at 2.67V to a current of 500 mA.
9. Discharge at −120 W to 1.8V.
10. Charge at 15 A to 2.67V, then at 2.67V to a current of 500 mA.
11. Discharge at −130 W to 22 Ah or 1.8V.
12. Charge at 15 A to 2.67V, then at 2.67V to a current of 500 mA.
13. Discharge at −140 W to 22 Ah or 1.8V.
14. Charge at 15 A to 2.67V, then at 2.67V to a current of 500 mA.
15. Discharge at −155 W to 22 Ah or 1.8V.
16. Charge at 15 A to 2.67V, then at 2.67V to a current of 500 mA.
17. Discharge at −110 W to 1.8V or 15 min, then at 1.8V to 15 min.
18. Repeat steps 16 and 17 100 times.
19. Go to step 6 to repeat steps 6-18 once, for a total of 225 cycles.
   Step 1 is the maiden charge, which starts at low current to avoid excessive current densities during the initial production of sodium in the negative electrode. Steps 3 and 4 are mild conditioning cycles before the start of the UPS testing. Step 7 is a low-power cycle to measure cell resistance at deep Depths of Discharge (DoD). Steps 9, 11, 13, and 15 are high-power discharges to test the capability of our cells beyond the 110 W UPS qualification cycles. Steps 16 and 17 are the representative UPS qualification cycles. The protocol ends after only 225 cycles, to maximize cell-testing throughput while still getting enough data to make initial performance comparisons.

### Examples 1, 2, and 3 (E-1, E-2, E-3) and Comparative Example 1 and 2 (CE-1 and CE-2)

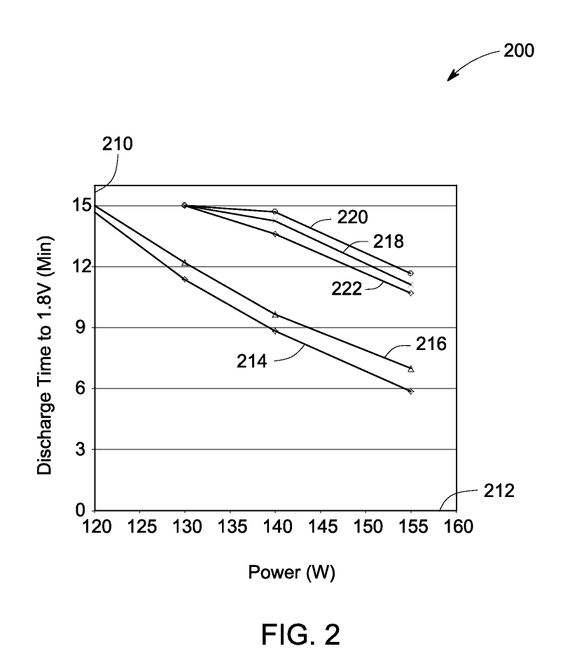

Cells having similar compositions were assembled and tested according to the testing protocol. The positive electrode compositions are given in Table 2, and the cell testing results are provided in FIG. 2.

TABLE 2

| | | | | | | | | Weight percent of NaI with |
|---|---|---|---|---|---|---|---|---|
| Examples | Al | NaI | NaF | NaCl | Fe | Ni | NaAlCl₄ | respect to sodium halides |
| CE-1 | 2 | 0 | 0 | 99.01 | 6.89 | 124.18 | 119 | 0.00 |
| CE-2 | 2 | 0 | 5.63 | 94.26 | | 124.18 | 119 | 0.00 |
| E-1 | 2 | 2 | 0 | 97.84 | | 124.18 | 119 | 0.91 |
| E-2 | 2 | 2 | 5.63 | 93.09 | | 124.18 | 119 | 0.91 |
| E-3 | 1 | 1 | 2.18 | 96.85 | | 124.18 | 119 | 0.46 |

The cell testing results are provided in FIG. 2. For each composition, three cells were tested using the cell testing protocol. Referring to FIG. 2, a graph 200 shows the discharge time of cells in accordance with embodiments of the invention. The results shown in the graph were obtained for an average of about 10 cells, with the positive electrode being made from the compositions of E-1, E-2, E-3, CE-1, and CE-2. The graph includes discharge times at 120, 130, 140 and 155 W to 1.8 V, in minutes on the Y-axis 210, versus power on the X-axis 212. Curve 214 and curve 216 represent the results for CE-1 and CE-2 respectively, where 0 percent sodium iodide was employed. Curves 218, 220, and 222 represent E-1, E-2, and E-3 respectively. The results for cells E-1, E-2 and E-3, all of which contain amounts of sodium iodide within the specifications of this invention, are superior to the results for cells CE-1 and CE-2, which contain no sodium iodide. Nor does it appear necessary to include larger amounts of sodium iodide, as has been described elsewhere. Cell E-3 performs at the same level as cells E-1 and E-2, while containing only half as much sodium iodide.

The foregoing examples are illustrative of some features of the invention. The appended claims are intended to claim the invention as broadly as has been conceived; and the examples herein presented are illustrative of selected embodiments from a collection of all possible embodiments. Accordingly, it is Applicants' intention that the appended claims not be construed as limiting the illustrated features of the invention, by the choice of examples utilized. As used in the claims, the word “comprises” and its grammatical variants logically also subtend and include phrases of varying and differing extent. such as for example, but not limited thereto, “consisting essentially of” and “consisting of.” Where necessary, ranges have been supplied, and those ranges are inclusive of all sub-ranges there-between. It is to be expected that variations in these ranges will suggest themselves to a practitioner having ordinary skill in the art and, where not already dedicated to the public, the appended claims should cover those variations. Advances in science and technology may make equivalents and substitutions possible, that are not now contemplated by reason of the imprecision of language. These variations should be covered by the appended claims.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have a utility distinct from the utility of the reaction product or final material. Other subsequent changes, transformations, or reactions may result from bringing the specified reactants and/or components together under the conditions called for pursuant to this disclosure. In these other subsequent changes, transformations, or reactions, the reactants, ingredients, or the components to be brought together may identify or indicate the reaction product.

All ranges disclosed herein are inclusive of the endpoints, and the endpoints are combinable with each other. The terms “first,” “second,” and the like, as used herein, do not denote any order, quantity, or importance, but rather are used to distinguish one element from another. While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A positive electrode composition comprising:
at least one electroactive metal selected from the group consisting of titanium, vanadium, niobium, molybdenum, nickel, cobalt, chromium, manganese, silver, antimony, cadmium, tin, lead, iron, and zinc;
sodium iodide present in an amount in a range from about 0.1 weight percent to about 0.9 weight percent, based on the weight of the positive electrode composition;
a first alkali metal halide; and
an electrolyte salt comprising a reaction product of a second alkali metal halide and an aluminum halide, wherein the electrolyte salt has a melting point of less than about 300 degrees Celsius; and
wherein the first alkali metal halide and the second alkali metal halide independently comprise a halide selected from chlorine, bromine, and fluorine.

2. The positive electrode composition according to claim 1, wherein the electroactive metal comprises nickel.

3. The positive electrode composition according to claim 1, wherein the first and second alkali metals are independently selected from the group consisting of sodium, potassium, and lithium.

4. The positive electrode composition according to claim 1, wherein the electroactive metal is present in a range of from about 11 volume percent to about 19 volume percent, based on the volume of the positive electrode composition.

5. The positive electrode composition according to claim 1, wherein the positive electrode composition is substantially free of sulfur.

6. The positive electrode composition according to claim 1, further comprising sulfur in the form of molecular sulfur or a sulfur-containing compound.

7. The positive electrode composition of claim 6, wherein sulfur is present in an amount in a range from about 0.1 weight percent to about 3 weight percent, based on the total weight of the positive electrode composition.

8. The positive electrode composition according to claim 1, further comprising additional aluminum, in a form other than the aluminum halide.

9. The positive electrode composition according to claim 8, wherein the additional aluminum is present in a range of from about 0.2 volume percent to about 0.5 volume percent, based on the volume of the positive electrode composition.

10. An article comprising:
a positive electrode; which itself comprises:
at least one electroactive metal selected from the group consisting of titanium, vanadium, niobium, molybdenum, nickel, cobalt, chromium, manganese, silver, antimony, cadmium, tin, lead, iron, and zinc;
sodium iodide present in an amount in a range from about 0.1 weight percent to about 0.9 weight percent, based on the weight of the positive electrode composition;
a first alkali metal halide; and
an electrolyte salt comprising a reaction product of a second alkali metal halide and an aluminum halide, wherein the electrolyte salt has a melting point of less than about 300 degrees Celsius; and
wherein the first alkali metal halide and the second alkali metal halide independently comprise a halide selected from chlorine, bromine, and fluorine.

11. The article according to claim 10, in the form of an energy storage device.

12. The article according to claim 10, in the form of an uninterruptable power supply device.

13. An energy storage device comprising:
(a) a first compartment comprising an alkali metal;
(b) an anode current collector;
(c) a positive electrode current collector;
(d) a second compartment comprising a positive electrode composition, the positive electrode composition comprising:
at least one electroactive metal selected from the group consisting of titanium, vanadium, niobium, molybdenum, nickel, cobalt, chromium, manganese, silver, antimony, cadmium, tin, lead, iron, and zinc;
sodium iodide present in an amount in a range from about 0.1 weight percent to about 0.9 weight percent, based on the weight of the positive electrode composition;
a first alkali metal halide; and
an electrolyte salt comprising a reaction product of a second alkali metal halide and an aluminum halide, wherein the electrolyte salt has a melting point of less than about 300 degrees Celsius; and
wherein the first alkali metal halide and the second alkali metal halide independently comprise a halide selected from chlorine, bromine, and fluorine; and
(e) a solid separator capable of transporting alkali metal ions between the first and the second compartments.

14. The energy storage device according to claim 13, wherein the device is rechargeable over a plurality of cycles.

15. The energy storage device according to claim 13, wherein the solid separator comprises a beta-alumina, a beta″-alumina, a gamma alumina, a micromolecular sieve, a silicon nitride, or a silicophosphate.

16. The energy storage device according to claim 13, wherein the solid separator comprises a shape which is flat, undulate, domed or dimpled, or comprises a shape with a cross-sectional profile that is an ellipse, triangle, cross, star, circle, cloverleaf, rectangular, square, or multi-lobal.

17. An energy storage battery comprising a plurality of rechargeable energy storage devices in accordance with claim 13.

18. An uninterruptable power supply device, comprising:
a positive electrode; which itself comprises:
at least one electroactive metal selected from the group consisting of titanium, vanadium, niobium, molybdenum, nickel, cobalt, chromium, manganese, silver, antimony, cadmium, tin, lead, iron, and zinc;
sodium iodide present in an amount in a range from about 0.1 weight percent to about 0.9 weight percent, based on the weight of the positive electrode composition;
a first alkali metal halide; and
an electrolyte salt comprising a reaction product of a second alkali metal halide and an aluminum halide, wherein the electrolyte salt has a melting point of less than about 300 degrees Celsius; and
wherein the first alkali metal halide and the second alkali metal halide independently comprise a halide selected from chlorine, bromine, and fluorine.

19. A method for forming an energy storage device, comprising:
providing a housing having an interior surface defining a volume;
disposing a separator inside the housing, wherein the separator has a first surface that defines at least a portion of a first compartment, and a second surface that defines a second compartment; wherein the first compartment is in ionic communication with the second compartment through the separator;
disposing a positive electrode composition in the second compartment, wherein the positive electrode composition comprises:
at least one electroactive metal selected from the group consisting of titanium, vanadium, niobium, molybdenum, nickel, cobalt, chromium, manganese, silver, antimony, cadmium, tin, lead, iron, and zinc;
sodium iodide present in an amount in a range from about 0.1 weight percent to about 0.9 weight percent, based on the weight of the positive electrode composition;
a first alkali metal halide; and
an electrolyte salt comprising a reaction product of a second alkali metal halide and an aluminum halide, wherein the electrolyte salt has a melting point of less than about 300 degrees Celsius; and
wherein the first alkali metal halide and the second alkali metal halide independently comprise a halide selected from chlorine, bromine, and fluorine.

20. The method according to claim 19, wherein the electroactive metal is present in a range of from about 11 volume percent to about 19 volume percent, based on the volume of the positive electrode composition.

21. A positive electrode composition comprising:
nickel in an amount in a range from about 10 volume percent to about 20 volume percent, based on the volume of the positive electrode composition;
sodium iodide present in an amount in a range from about 0.1 weight percent to about 0.9 weight percent, based on the weight of the positive electrode composition;
a first alkali metal halide selected from sodium chloride, sodium fluoride, sodium bromide, and a combination thereof; and
an electrolyte salt comprising a reaction product of
(a) a second alkali metal halide selected from sodium chloride, sodium fluoride, sodium bromide, and a combination thereof; and
(b) an aluminum halide,
wherein the electrolyte salt has a melting point of less than about 300 degrees Celsius.
